(19) United States
(12) Patent Application Publication
(10) Pub. No.: US 2025/0346219 A1
(43) Pub. Date: Nov. 13, 2025

(54) BRAKE SYSTEM FOR MOTOR VEHICLES, HAVING AN ACTUATOR

(71) Applicant: Continental Automotive Technologies GmbH, Hannover (DE)

(72) Inventors: Sirko Loechel, Giessen (DE); Jens Trostorf, Bellingen (DE)

(73) Assignee: Continental Automotive Technologies GmbH, Hannover (DE)

(21) Appl. No.: 18/866,791

(22) PCT Filed: Apr. 26, 2023
(86) PCT No.: PCT/DE2023/200083

§ 371 Date: Nov. 18, 2024

(30) Foreign Application Priority Data
May 18, 2022 (DE) 10 2022 204 955.1

(51) Int. Cl. B60T 13/66

(52) U.S. Cl. CPC B60T 13/662; B60T 2270/402; B60T 2270/404

(57) ABSTRACT

A brake system for motor vehicles with wheel brakes, with a reservoir for brake fluid and a pressure provision device and a pressure modulator, The brake system comprises a primary brake system with the hydraulic pressure provision device and the pressure modulator, to which two hydraulic wheel brakes are hydraulically connected. The brake system comprises a dry secondary brake system with two further wheel brakes, wherein a brake request apparatus and an open loop and closed loop control unit connected to it are provided. The open loop and closed loop control unit is configured to actuate the pressure provision device based on a transmitted brake request.

### TECHNICAL FIELD

The embodiments relate to a brake system for motor vehicles with wheel brakes, has a reservoir for brake fluid and a pressure provision device and a pressure modulator.

### BACKGROUND

Known brake systems act hydraulically on two circuits, diagonally or in a black and white split. In a brake-by-wire system, an actuator takes over this pressure actuation. The driver depresses a simulator, a brake pressure request is generated and implemented by the actuator. The brake pressure at the front and rear axles is identical.

For the brake systems described above the availability of the brake system depends, inter alia, on the intact brake line. To detect faults in the brake system, complex functions are required that detect air and leaks and isolate the faulty circuit. Successful fault detection results in fault-induced reduced braking performance. Redundancy is not provided here to compensate for the faulty circuit.

Hydraulic systems also have installation of hoses and filling during production is complex. The aim is to find solutions that enable the avoidance of liquids and to reduce processes and/or work steps. Braking along the ideal brake force balance as well as axle-by-axle blending for recuperative braking cannot be achieved with current systems without losses of efficiency or comfort.

Prior art has disclosed a combined brake system for motor vehicles with a hydraulic brake system for the front axle, which brake system is designed as a “brake-by-wire” brake system with an electrically controllable pressure provision device which comprise wheel brakes which can each be actuated by an electromechanical actuator.

The prior art also describes a brake system which comprises a simulation unit with a simulator, which can be actuated with the aid of a brake pedal, and an auxiliary module, wherein the auxiliary module comprises a hydraulic unit with a pressure provision device for active pressure build-up in at least two of the wheel brakes.

Prior art has also disclosed a brake system with an additional module, which brake system comprises a hydraulic unit with a pressure provision device for active pressure build-up in at least two wheel brakes. There is no hydraulic and/or mechanical operative connection between the brake pedal and the wheel brakes.

The embodiments are therefore based on the object of providing a reliable and flexibly installable brake system.

### SUMMARY

A brake system comprises a primary brake system with the hydraulic pressure provision device and the pressure modulator, to which two hydraulic wheel brakes are hydraulically connected. The brake system comprises a dry secondary brake system with two further wheel brakes. A brake request apparatus and an open loop and closed loop control unit are connected to the dry secondary brake system. The open loop and closed loop control unit is configured to actuate the pressure provision device based on a transmitted brake request.

The embodiments are based on the consideration that there is a need for reliable and robust brake-by-wire systems which can be flexibly integrated into given vehicle environments.

As has now been recognized, these requirements can be met by combining a hydraulic single-circuit brake system with an electric single-circuit brake system to provide a semi-dry brake system. A service brake system (semi-dry brake system) for motor vehicles has hydraulically actuable wheel brakes on a first axle and electromechanically actuable (i.e. dry) wheel brakes on the other axle, wherein the pressure provision device or actuating device is coupled by-wire to a brake pedal or a brake request apparatus, with the result that there is no hydraulic and/or mechanical intervention of the driver on the wheel brakes.

The brake system does not have a simulator valve due to the by-wire connection. The axles can be braked independently of each other. There is no need for two independent open loop and closed loop control units, and there is no need for a separate power supply.

The by-wire system acts hydraulically only on the front axle. The subsystem may comprise a separate brake actuation means (pedal unit) and a hydraulic block with an ECU and actuator. The actuator is electrically connected to the pedal unit. The by-wire system serves as the primary brake system and can be used as a master/host for actuating a secondary brake system. The entire system is combined with an electric brake for the rear axle. This means that the entire system is designed as a two-circuit and redundant system.

The pressure provision device may have only one hydraulic pressure chamber, which is connected or can be connected hydraulically to the pressure modulator. The brake system thus comprises a hydraulic brake circuit or is of hydraulically single-circuit configuration.

The brake request apparatus is designed as a driver's brake request detection device. This will enhance the brake system as a brake-by-wire brake system. The driver has no hydraulic or mechanical intervention on the wheel brakes.

In one embodiment, the brake system comprises a pedal unit, wherein the driver's brake request detection device is integrated into the pedal unit. The pedal unit generates a driver's request and sends it to the brake system. To this end, the pedal unit has a separate logic circuit. This solution generates a signal-based information item as a result of the actuation, which information item is evaluated by the brake system/brake control unit and is translated into a driver's brake request, respectively deceleration request. This results in a brake torque to be implemented.

The pedal unit comprises a dry pedal and a redundantly designed pedal sensor.

In one alternative embodiment or in combination, the brake request apparatus is configured as an autonomous driver or at least one autonomous driving function, which generates a deceleration request. The term “autonomous driver” here may include functions that can generate a brake request autonomously, without driver actuation. This means that comfort and assistance functions are to be understood, ranging from hill start aids, auto hold function by way of distance control machines, emergency brakes and autopilot systems.

The open loop and closed loop control unit actuates both the primary brake system and the secondary brake system.

The primary brake system and the secondary brake system can each be configured with a dedicated ECU open loop and closed loop control unit, with the primary brake system having the lead. If the primary brake system is the host, the secondary brake system can be designed as a hardware-only solution. The primary brake system thus takes over the actuation. Any function and software contents of the secondary brake system are then located in the open loop and closed loop control unit of the primary brake system.

The unit can be accommodated in the engine compartment, with the result that shorter lines can be used to the front axle, saving costs incurred when hydraulic calipers are fitted to the rear axle. For the purpose of axle load distribution, the front axle must have a stronger design. The response behavior of the hydraulic brake can be modulated better according to the current state of the art.

The two hydraulic wheel brakes may be designed as front wheel brakes. The rear wheel brakes may be designed as electromechanical wheel brakes (EMB).

The pressure modulator may have an inlet valve and an outlet valve for each connected wheel brake. The inlet and outlet valves may be designed to be electrically actuable.

A pressure switching valve is switched between the pressure provision device and the pressure modulator or the inlet valves. With the help of this pressure switching valve, the pressure provision device or the actuator can be disconnected from the pressure modulator or connected to it as required. The pressure switching valve is designed to be electrically actuable.

In addition to the pressure switching valve and the inlet and outlet valve, the primary brake system comprises no further electrically actuable valve for each connected wheel brake. The primary brake system comprises, as electrically actuable valves, exclusively the pressure switching valve, two inlet valves and two outlet valves.

No hydraulic connecting line which connects the ports of the inlet valves facing the pressure provision device to the reservoir and which, in the de-energized state of the brake system, provides a pressure equalization of the connected wheel brakes via the inlet valves with the reservoir is provided in the primary brake system.

In one embodiment, the respective inlet valve and the respective outlet valve are designed as a normally open valve, wherein the pressure switching valve is designed as a normally closed valve. In this case, a pressure equalization (e.g. of the connected wheel brakes) with the reservoir (especially when the brake system is de-energized) can be performed via the outlet valves. If there is a residual pressure in the brake system in a wheel brake, this can be dissipated passively by the normally open outlet valves in the direction of the equalizing tank/reservoir. Therefore, the vehicle cannot be unintentionally immobilized by braking by this part of the brake system. No linear actuator with equalizing openings or snifter bores is required to achieve pressure equalization with the container.

In an alternative embodiment, the respective inlet valve is designed as a normally open valve and the respective outlet valve is designed as a normally closed valve, wherein the pressure switching valve is designed as a normally open valve, and wherein the pressure provision device is designed in such a way that a hydraulic connection to the reservoir is formed in the idle state. The hydraulic connection exists here between the pressure chamber of the pressure provision device and the reservoir. In this case, the pressure equalization (e.g. of the connected wheel brakes) can take place directly via the actuator in the de-energized case (de-energized state of the brake system). The wheel valves can be used in a standard configuration, with the result that fewer software adaptations have to be performed on the functions. The total current consumption is reduced.

In one embodiment of the brake system, at least two wheel brakes have an integrated parking brake (IPB). For example, the hydraulic front wheel brakes have combined calipers which, in addition to the hydraulic service brake, each also comprise an integrated parking brake. In alternative embodiments, the dry rear wheel brakes have an IBP, or all four wheel brakes have an IBP. One of the two subsystems of the brake system (primary or secondary brake system) must take over or ensure secure stopping, which is carried out by the electromechanical brakes (EMB) on the rear axle. If the EMB cannot carry out this functionality and/or redundancy is desired, an IPB combination caliper on the front axle is a solution. The IPB on the front axle can firstly take over the secure stopping of the vehicle and secondly, in the event of a hydraulic fault or failure, the IPB can partially also participate in braking on the axle (IPB Dynamic Apply).

The open loop and closed loop control unit is configured in such a way that it actuates the respective IBP in a fall-back level in order to build up braking torque. In particular, the IPB is actuated, which acts on the failed brake circuit or assists the driver if the driver brakes hydraulically without boosting.

The monitoring and testing routines can be simplified. By reducing the complexity of the brake system, a cost reduction is made possible. The hydraulic subsystem can be combined with various electrical brake systems. A master cylinder is not required because the brake request is transmitted electronically by the pedal unit.

The actuator can be of smaller design than known brake systems because it supplies only one brake circuit. Axle-by-axle blending is possible for vehicles capable of recuperation. Braking along the optimum brake force distribution is possible. There are also differences in terms of acoustics and space utilization, since the actuator does not have to be arranged on the bulkhead. This also results in less noise and NVH (noise, vibration, harshness) behavior. Further, crash performance differs since the brake system cannot enter the driver's footwell. The bulkhead does not have to take accommodating the heavy brake system into account in its design.

The described brake system can comprise, as a secondary brake system, an electric brake system at the rear axle with electric calipers, electric drum brakes, wheel hub motors, and electric motors recuperating on the rear axle.

Due to its redundant design, the brake system provides increased safety, since the front and rear axles can be actuated separately in the event of failure of the other subsystem. Unlike one-box designs, the brake system is a distributed brake system. Defined interfaces can be used to enable the components to be exchanged crossways. When driving, braking along the optimum brake force distribution affords stability down to the limit.

### BRIEF DESCRIPTION OF THE DRAWINGS

One exemplary embodiment will be described in greater detail in the following text with reference to a drawing, in which, in a schematic view:

FIG. 1 shows a primary brake system in a first embodiment in a passive state;

FIG. 2 shows the primary brake system according to FIG. 1 in an active state;

FIG. 3 shows a brake system in one embodiment;

FIG. 4 shows a brake system in a further embodiment; and

FIG. 5 shows a primary brake system in a further embodiment.

### DETAILED DESCRIPTION

In all the figures, identical parts are provided with the same designations.

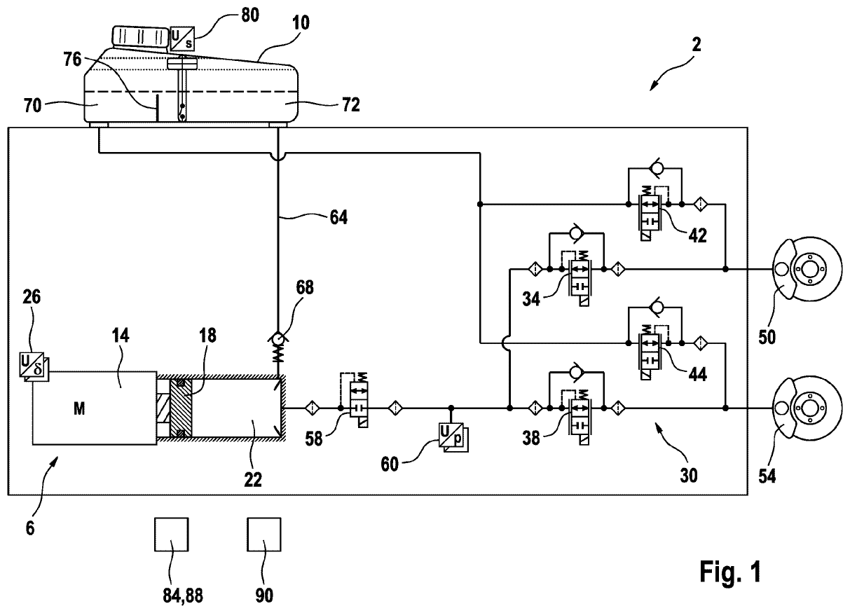

FIG. 1 shows a primary brake system 2 which is designed as a single-circuit brake-by-wire system. It comprises a hydraulic block (not shown) with a pressure provision device 6, which is designed as a linear actuator with attached reservoir 10 for brake fluid or brake medium. The pressure provision device 6 has a motor 14, with the aid of which a pressure piston 18 is moved into a hydraulic pressure chamber 22, and a redundantly designed, motor position sensor 26 which may be designed as a rotation angle sensor. The motor 14 may be designed as an electric motor. For transforming the rotational movement of the rotor of the motor 14 into a translational movement of the pressure piston 18, a rotational/translational gear mechanism is provided which may be designed as a ball screw drive (KGT).

The hydraulic block comprises a pressure modulator 30 with four wheel valves 34, 38, 42, 44. Here, an inlet valve 34 and an outlet valve 42 are hydraulically connected to a first front wheel brake 50, and an inlet valve 38 and an outlet valve 44 are hydraulically connected to a second front wheel brake 54. A check valve which prevents the flow of brake medium from the pressure chamber 22 in the direction of the brake 50, 54 is connected in each case in parallel to the respective inlet valve 34, 38. A check valve which prevents the flow of brake medium from the brake 50, 54 in the direction of the pressure chamber 22 is connected in each case in parallel to the respective outlet valve 42, 44. The outlet valves 42, 44 are connected to the reservoir 10 via compensating lines. The inlet valves 34, 38 and the outlet valves 42, 44 are in this case of normally open design.

A pressure switching valve 58 which is in this case of normally closed design and which separates the linear actuator from the system or the pressure modulator 30 as required is arranged between the pressure chamber 22 and the pressure modulator 30. The operating pressure, i.e. the prevailing pressure in the pressure chamber 22, is measured with the aid of a redundantly designed pressure sensor 60. The pressure chamber 22 is hydraulically connected to the reservoir 10 by way of a replenishing line 64, into which a check valve 68 is connected. The reservoir 10 comprises two separate chambers 70, 72 which are separated from each other by an intermediate wall 76 up to a predetermined height of the intermediate wall. The pressure chamber 22 is hydraulically connected to the two chambers 70, 72, with the result that, in the event of leakage in one of the two chambers 70, 72, brake fluid is still available. A redundantly designed brake fluid level sensor 80 is provided for measuring the brake fluid level.

The primary brake system 2 comprises only five electrical actuable valves, namely the pressure switching valve 58 and the four wheel valves 34, 38, 42, 44.

The primary brake system 2 further comprises a brake request apparatus 84, which is configured in the present case as a driver's brake request detection apparatus 88 and is connected to a (not shown and for example dry) brake pedal on the signal input side. In one alternative embodiment, the brake request apparatus 84 can be a brake request generation apparatus of an autonomously driving vehicle. This takes over the deceleration request based on the autonomous driving function and sends it to the brake control unit as an alternative to the brake pedal. The brake request detection does not have to be generated by the driver via the actuating device (pedal unit). Alternatively, the brake request generation can also be performed by a function that is not based on the actuating device, i.e. is not directly/immediately induced by the driver. The brake request detection between the driver and functions can overlap.

The brake system 2 further comprises an open loop and closed loop control unit 90 for actuating the pressure provision device 6 and the valves 34, 38, 42, 44, 58. FIG. 1 shows the primary brake system 2 in the passive state without a pressure position.

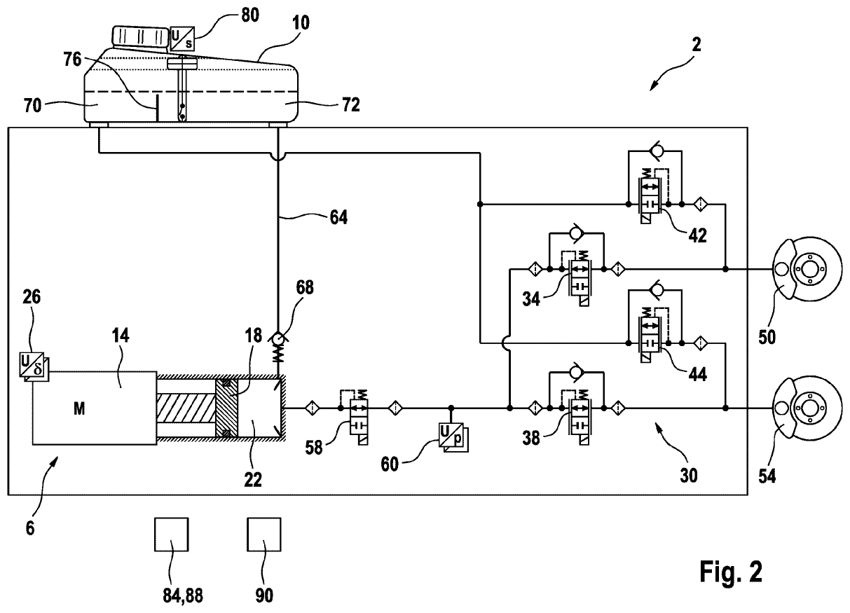

In the active state of the brake system 2, which is shown in FIG. 2, the outlet valves are closed. If a pressure actuating request reaches the linear actuator or the pressure provision device 6, the open loop and closed loop control unit 90 opens the pressure switching valve 58 and the linear actuator builds up pressure in the wheel brake or brakes 50, 54.

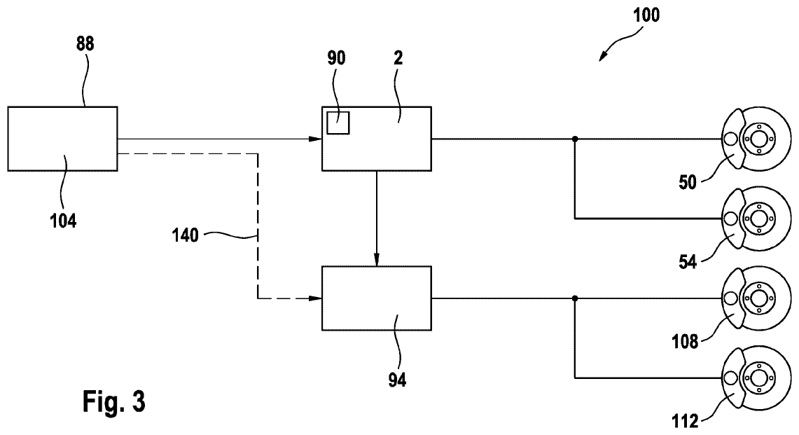

If the driver actuates the brake pedal or the pedal unit, a deceleration request is generated in the driver's brake request detection apparatus 88 and transmitted to the brake control unit or the open loop and closed loop control unit 90. The system shown in FIG. 1 which acts on the front axle is the primary brake system (PBS) 2. A brake system 100 further comprises a secondary brake system (SBS) 94, see FIG. 3 which acts on the rear axle in the present case.

The hydraulic primary system or primary brake system 2 can be combined with a brake system 94 acting electronically on the rear axle, with the result that both axles of the vehicle are braked. The primary brake system 2 sends a deceleration request to the secondary brake system 94 here. The secondary brake system 94 previously transmits its availability to the primary brake system 2 here. Moreover, the primary brake system 2 derives a pressure demand from the deceleration request, which pressure demand it implements at the front axle. At the same time, a corresponding torque for the deceleration is output on the rear axle.

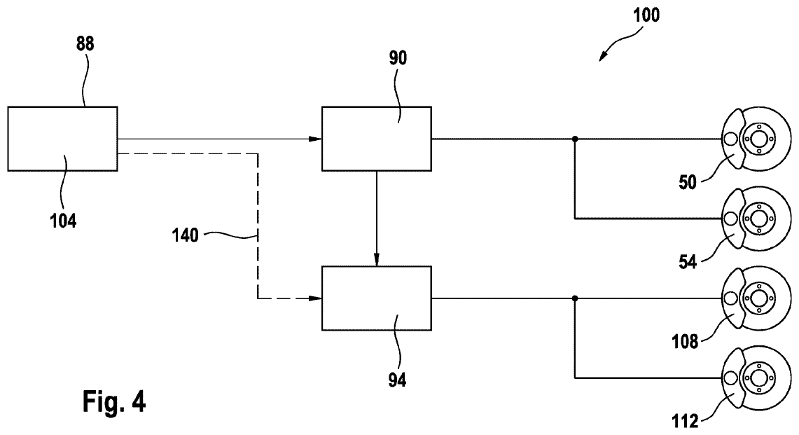

This functionality is shown in FIG. 3, in which a pedal unit 104 and two rear wheel brakes 108, 112 of the secondary brake system 94, which is of dry design in the present case, are also shown. The two rear wheel brakes are designed as electromechanical brakes here. The driver's brake request detection apparatus 88 is integrated in the pedal unit 104 in the present case. The connection of the driver's brake request detection apparatus 88 to the secondary brake system 94 is a connection as a fall-back level. If the primary brake system 2 fails and cannot send a request to the secondary brake system 94, the secondary brake system 94 can also receive the request from the pedal unit via the by-pass. (fault state PBS 2 failed). This must also apply in the event that the request does not come from the pedal unit 104, but from a function or the autonomous/virtual driver. A back-up path 140 that is shown in FIGS. 3 and 4 as an arrow, symbolizes a path representing a fall-back level/degradation or fault state. The fall-back level is described below.

The ECU or open loop and closed loop control unit 90 of the primary brake system (PBS) 2 is used in an alternative embodiment (shown in FIG. 4) as a host for the overall system or brake system 100. An incoming deceleration request is calculated in the driver's brake request detection apparatus 88 and is distributed to a corresponding braking torque for the front and rear axles. The open loop and closed loop control unit 90 of the primary brake system 2 acts as a host. The secondary brake system 94 is no longer an independent unit here, as shown in FIG. 3. The secondary brake system 94 acts as an IPB (integrated HW). The secondary brake system 94 is thus integrated into the primary brake system 2. The pedal unit 104 transmits a brake request or a deceleration request to the primary brake system 2. The primary brake system 2 receives the request as a host and calculates a torque for the front axle and the rear axle. In the primary brake system 2, the respective target requirement is transferred to the linear actuator (LAC) and, in the case of the secondary brake system 94, to the associated actuator or the EMB.

If any part of the system fails, the vehicle can still be decelerated via the intact part of the system. If the actuator of the PBS fails, the front axle is not hydraulically braked. A direct intervention is not possible due to the decoupling of the actuator. In this case, the vehicle can only be decelerated via the rear axle. The following fault states or (fall-back) levels or modes can be implemented. The first mode is a normal mode. The brake system 100 is in a fault-free state and operates as described above. In a second mode, the primary brake system 2 has failed or has a malfunction while the secondary brake system 94 is available. The secondary brake system 94 can convert a brake torque from a pedal unit 104 or from a function on the rear axle.

In a third mode, there is a defect or malfunction of the secondary brake system 94, with the result that only the primary brake system 2 can be used to brake. The brake system 100 can only implement the deceleration request on the front axle via the primary brake system 2.

In a fourth mode 4, the linear actuator of the primary brake system 2 is defective or has a malfunction. The open loop and closed loop control unit 90 functions such that the brake system 100 can be operated in a cooperative mode. The primary brake system 2 can still transmit the deceleration request to the secondary brake system 2.

In a fifth mode which is an emergency mode, the pedal unit 104 is defective or has a malfunction. The driver can no longer brake independently. The deceleration request is only possible via a secondary device (parking brake button or transmission P) or via an autonomously braking function.

The brake system 100 can have combination brake calipers with an integrated parking brake (IPB) on the front axle brakes 50, 54. The IPB can be used here for secure stopping of the vehicle. In this case, the IPB can also be used in the event of failure of the actuator or the pressure provision device 6. If the actuator cannot hydraulically build up pressure on the front axle, the IPB can mechanically decelerate. This creates, as it were, a fall-back level in the primary brake system 2. This corresponds to an “IPB Dynamic Apply” according to the VDA standard 305-100.

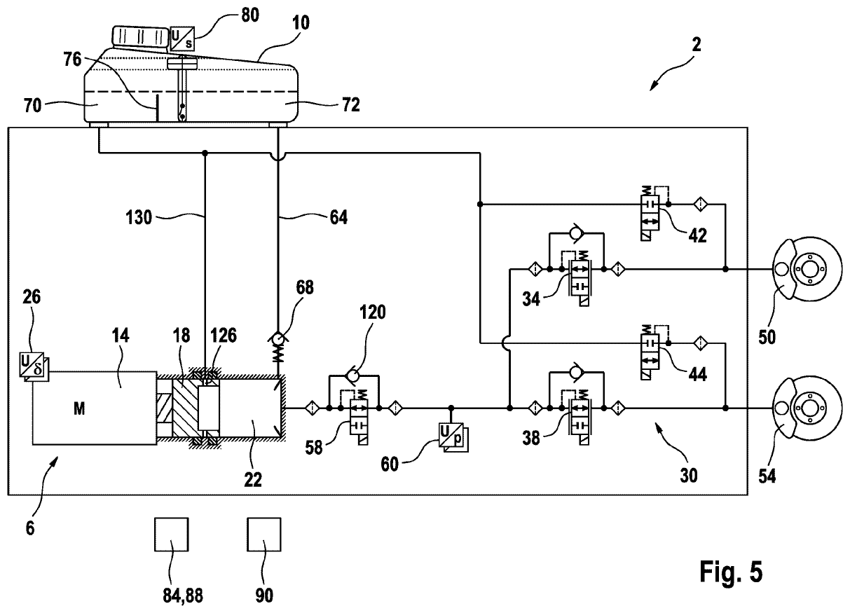

FIG. 5 shows a second embodiment of a primary brake system 2 of a brake system 100, which enables a passive pressure equalization via the pressure provision device 6 and the linear actuator. For this purpose, the pressure switching valve 58 is designed as a normally open (NO) valve. In this case, the pressure provision device 6 is designed such that in its idle state, i.e. the de-energized state in which the pressure piston 18 is fully retracted, volume can be returned to the reservoir 10. In the illustrated exemplary embodiment, this is realized by at least one equalizing opening (“snifter hole”) 126, via which the pressure provision device 6 in the idle state is hydraulically connected to the reservoir by an equalizing line 130. Alternatively, a hydraulic connection with a valve can also be provided, by way of which an equalization can take place in the idle state.

The inlet valves 34, 38 are designed in this embodiment as NO valves and the outlet valves 42, 44 as NC valves. Therefore, no valves need to be activated during hydraulic braking. The same valve set up can be used by other systems with normally open inlet valves and normally closed outlet valves. In addition, the pressure switching valve 58 or PFV (pressure feed valve) is designed as a normally open valve. This results in low current consumption and longer service life, since the valves are switched and energized less. In addition, fewer valve switch operations result in less noise. The pressure switching valve 58 does not need to be switched to build up pressure.

1. A brake system for motor vehicles with wheel brakes comprising:
a primary brake system with a hydraulic pressure provision device and a pressure modulator, to which two hydraulic wheel brakes are hydraulically connected; and
a dry secondary brake system with two further wheel brakes comprising:
a brake request apparatus; and
an open loop and closed loop control unit connected to the brake request apparatus, wherein the open loop and closed loop control unit is configured to actuate the pressure provision device based on a transmitted brake request.

2. The brake system as claimed in claim 1, wherein the brake request apparatus is a driver's brake request detection device.

3. The brake system as claimed in claim 2, with a pedal unit, wherein the driver's brake request detection device is integrated into the pedal unit.

4. The brake system as claimed in claim 2, wherein the brake request apparatus is an autonomous driver.

5. The brake system as claimed in claim 1, wherein the open loop and closed loop control unit actuates both the primary brake system and the secondary brake system.

6. The brake system as claimed in claim 1, wherein the two hydraulic wheel brakes are designed as front wheel brakes.

7. The brake system as claimed in claim 1, wherein a pressure switching valve is switched between the pressure provision device and the pressure modulator.

8. The brake system as claimed in claim 7, wherein the pressure modulator comprises an inlet valve and an outlet valve for each connected wheel brake.

9. The brake system as claimed in claim 8, wherein, in addition to the pressure switching valve and the inlet and outlet valve, the primary brake system comprises no further electrically actuable valve for each connected wheel brake.

10. The brake system as claimed in claim 8, wherein the respective inlet valve and the respective outlet valve are a normally open valves, and wherein the pressure switching valve is a normally closed valve.

11. The brake system as claimed in claim 8, wherein the respective inlet valve is a normally open valve and the respective outlet valve is a normally closed valve, and wherein the pressure switching valve is a normally open valve, and wherein the pressure provision device is designed such that a hydraulic connection to the reservoir is formed in the idle state.

12. The brake system as claimed in claim 1, wherein at least two wheel brakes of the wheel brakes have an integrated parking brake.

13. brake system as claimed in claim 12, wherein the open loop and closed loop control unit is configured to actuate the respective integrated parking brake in a fall-back level.
